(19) United States
(12) Patent Application Publication
(10) Pub. No.: US 2025/0364797 A1
(43) Pub. Date: Nov. 27, 2025

(54) SPLICES FOR FLAT MAGNETIC WIRES

(71) Applicants: TE Connectivity Italia Distribution S.r.l., Torino (IT); TE Connectivity India Private Limited, Bangalore (IN)

(72) Inventors: Fabio DE PASQUALE, Collegno (IT); Clinton PEREIRA, Bangalore (IN); Ugo AIME, Collegno (IT)

(21) Appl. No.: 19/212,943

(22) Filed: May 20, 2025

(30) Foreign Application Priority Data
May 24, 2024 (EP) 24177977.6

(51) Int. Cl. H02G 15/08

(52) U.S. Cl. CPC H02G 15/08

(57) ABSTRACT

Splice for the electrical connection of flat magnetic wires includes a base, a first tine and a second tine, each protruding from one of the two opposite extremities of the base so as to form a U-shaped structure. The base of the splice is flat so as to define an XY plane, wherein the Y direction is parallel to the insertion direction of the flat magnetic wire into the splice. The first tine and the second tine may be asymmetric, so as to allow an overlapping crimping of the first tine and the second tine around the flat magnetic wire. The splice, in an elongated state, may have a length greater than 19 mm for example comprised between 19.1 mm and 30 mm, for example of 20.95 mm or 28.51 mm.

### CROSS REFERENCE TO RELATED APPLICATIONS

This application claims the benefit of EP Application Serial No. 24177977.6, filed 24 May 2024, the subject matter of which is herein incorporated by reference in its entirety.

### BACKGROUND OF THE INVENTION

The subject matter herein relates to splices for electrical connections, such as splices for flat magnetic wires.

Currently, to connect flat magnetic wires, processes like brazing, soldering and welding are normally used. These processes require wire preparation, because it is necessary to pre-strip the wires, heating processes and the construction of designed soldering stations along the production line. In this way, the costs of the termination process are high and the processes are often time consuming and not as precise as desirable: the quality of the termination is often not enough. Moreover, conventional processes are not environment friendly and they also imply possible risks for the operators implementing them.

There are several reasons why it is necessary to find more efficient techniques to connect flat magnetic wires. For example, flat magnetic wires improve the filling factor in winding process and permit to exchange more electrical power than the standard round wire. Moreover, flat magnet wires permit a better heat dissipation, enable to improve the design of the coil, improve the efficiency of the magnetic field, due to the better frequency characteristics, and enable to improve the design of the coil bringing to a more efficient magnetic field. A flat magnetic wire can be the termination of the stator of a high power electric motor, for example of an electric car.

Conventional flat magnetic wire typically include a conductive core and an insulating coating layer. The conductive core is made, for example of copper, or any other suitable conductive material, and the insulting coating layer is made of an insulating material, for example one to four layers of polymer film. The dimensions of a flat magnetic wire can be, for example, between 1 mm and 6 mm thickness and 3.15 mm and 20 mm width.

As known from the state of the art, in order to crimp a splice around a wire, a crimper device, comprising an anvil on which the splice is placed and a crimper to crimp the splice, can be used. The wire to be connected is put into the splice, then the crimper crimps the splice on top of the wire.

Standard splices known from the state of the art are not suitable to connect flat magnetic wire, because they do not have the suitable shape and/or dimensions. For example, they are too small to host a flat magnetic wire and/or they do not allow a proper crimping of the tines around a flat magnetic wire.

Crimping is a green process. No soldering or any chemical process are involved. In this way, the environmental problem related to these processes are avoided and also the possible risks for the operators.

There is a need to improve the termination of flat magnetic wires so as to obtain a process that does not require the pre-stripping of the wires.

### BRIEF DESCRIPTION OF THE INVENTION

In one embodiment, splices are provided that are used to connect flat magnetic wires. The splices for the flat magnetic wires may be used for a stator of an electric motor, such as HAIRPIN motors. Embodiments of the splice may provide a termination for flat magnetic wires that is precise. Embodiments of the splice may provide a termination for flat magnetic wires that produces reliable terminations. Embodiments of the splice may provide a termination for flat magnetic wires that is green and is not dangerous for the operator. Embodiments of the splice may provide a termination for flat magnetic wires that is cheaper and easier to implement than conventional processes.

In an embodiment, splices are provided for the electrical connection of flat magnetic wires, wherein the splices include a base, a first tine and a second tine, each protruding from one of the two opposite extremities of the base so as to form a U-shaped structure.

According to embodiments herein, the base of the splice is flat so as to define an XY plane, wherein the Y direction is parallel to the insertion direction of the flat magnetic wire into the splice. The splice having a flat base may be suitable to host a flat magnet wire, such as a flat magnet wire having a rectangular profile, along the XY plane, that fits onto a splice with a flat base.

According to embodiments herein, the first tine and the second tine may be asymmetric, so as to allow an overlapping crimping of the first tine and the second tine around the flat magnetic wire.

In the ambit of the present disclosure, the feature regarding the first tine and the second tine being asymmetric should be interpreted as meaning that the two tines are different, for example they have different shapes. The presence of the asymmetric tines renders the splice itself asymmetric, i.e. having two sides or halves that are not the same.

According to embodiments herein, splices, in an elongated state, may have a length greater than 19 mm, for example between 19 mm and 30 mm, for example of 20.95 mm or 28.51 mm.

In the ambit of the present disclosure, the elongate state of the splice corresponds to a state in which the tines of the splice lay on the same XY plane of the base of the splice, instead of protruding from the base and thus forming a U-shaped structure.

The splices solve the technical problem of improving the termination of a flat magnetic wires. More in particular, the various splices assure a proper crimping of the tines of the splice around the flat magnet wire, so that a stable electrical connection between the splice and the magnet wire can be guaranteed.

In embodiments herein, realizing the first tine and the second tine of the splice, so that they are asymmetric, assures an overlapping crimping of the first tine and the second tine around the flat magnetic wire. An overlapping crimping is a crimping in which the two tines of the splice overlap on top of each other and around the flat magnetic wire. By overlapping the first tine and the second tine a stable electrical connection of the flat magnetic wire and the splice can be assured. A stable connection is a connection having better performance in terms of lifetime, thermal shock resistance and/or resistance to vibrations.

In embodiments herein, the splice, in an elongated state, has a length greater than 19 mm for example comprised between 19 mm and 30 mm, for example of 28.51 mm, which allows assuring a F crimping of the first tine and the second tine around the flat magnetic wire. By making the splice longer, a stable electrical connection of the flat magnetic wire and the splice can be assured. A stable connection is a connection having better performance in terms of lifetime, thermal shock resistance and/or resistance to vibrations.

According to an embodiment, a splice is provided, wherein the splice comprises a base, a first tine and a second tine, each protruding from one of the two opposite extremities of the base so as to form a U-shaped structure and wherein the base is flat so as to define an XY plane, wherein the Y direction is parallel to the insertion direction of the flat magnetic wire into the splice, and wherein the first tine and the second tine are asymmetric, to allow an overlapping crimping of the first tine and the second tine around the flat magnetic wire.

According to an embodiment, the free end of the second tine is bent to form a curved structure, facing the inner surface of the first tine.

The curved structure can comprise, for example, an arc profile, with a curvature comprised between 1.6 mm and 2 mm, for example of 1.7 mm. Any other suitable profile can however be used.

Bending one of the free end of one of the tines of the splice, toward the inside of the splice, i.e. the part of the splice into which the flat magnetic wire is inserted, so as to form a curved structure, allow to better close the splice around the flat magnetic wire, assuring a stable electric connection of the same.

More in particular, when such a curved structure is realized on the free end of one of the tines, then an overlapping crimping of the splice around the flat magnetic wire can be performed. More in particular, the tine with the curved structure ends below the tine without the curved structure and in direct contact with the flat magnetic wire. Several experiments have shown that such an overlapping can be very convenient, i.e. it produces a very stable connection. A stable connection is a connection having better performance in terms of lifetime, thermal shock resistance and/or resistance to vibrations.

A connection obtained in this way is very stable in terms of lifetime, thermal shock resistance and resistance to vibrations.

According to an embodiment of the splice, in an elongated state, has a length greater than 19 mm, for example comprised between 19.1 mm and 30 mm, for example of 28.51 mm.

A standard splice for standard round wires, of the type known from the state of the art, has a length, in an elongated state, comprised between 2.9 mm and 19 mm.

The splice may have a length, in an elongated state, greater than 19 mm for example, comprised between 19.1 mm and 30 mm and is, therefore, longer than a standard splice. This feature contributes to adapt the splice so as to terminate a flat magnetic wire, which is larger and thicker that a standard round wire. Moreover, a more stable overlapping crimping can be realized.

The splice can be made of copper or any other suitable conducting material, for example, brass, tin plated brass, gold plated brass or copper-nickel.

According to an embodiment, a splice is provided, wherein the splice comprises a base, a first tine and a second tine, each protruding from one of the two opposite extremities of the base so as to form a U-shaped structure and wherein the base is flat so as to define an XY plane, wherein the Y direction is parallel to the insertion direction of the flat magnetic wire into the splice, and wherein the splice, in an elongated state, has a length greater than 19 mm, for example comprised between 19 mm and 23 mm, for example of 20.95 mm.

According to an embodiment, the inner surface of the first tine, facing the second tine, on the inner surface of the base 2, facing the inner space of the splice, and the inner surface of the second tine, facing the first tine, comprise a serration to peel the coating layer and to secure the flat magnetic wire inside the splice when the splice is crimped around the flat magnetic wire; the serration comprising a plurality of serration grooves; wherein each serration groove extends from the free end of the first tine to the free end of the second tine and wherein each groove has a different depth, in particular the depth of the serration grooves decreases along the Y direction.

The serration grooves have a profile, for example trapezoidal, which allows peeling the coating layer of the flat magnetic wire, when this is inserted and crimped into the splice. In this way, the electrical connection between the splice and the flat magnetic wire is assured.

The trapezoidal profile includes edges of each serration groove that cuts the coating layer of the flat magnetic wire, peeling it and allowing the electrical contact between the flat magnetic wire and the splice.

Moreover, the depth of the serration grooves decrease along the Y direction. The flat magnetic wire is inserted inside the splice along the Y direction, so that its terminal end corresponds to the shallowest groove. In this way, during the crimping, the flat magnetic wire can not be damaged.

According to an embodiment, serration grooves have a depth comprised between 7 mm and 11 mm, for example between 8 mm and 10 mm.

These values assure a proper peeling of the flat magnetic wire, to obtain the electrical connection between the flat magnetic wire and the splice.

According to an embodiment, the depth of the serration grooves decreases of a constant value so that the flat magnetic wire (FMW) is inserted into the splice parallel to the Y direction and so that the its free end corresponds to the shallower groove.

The indicated serration groove dimensions assure at the same time a proper peeling of the flat magnetic wire and ensure the magnetic wire not to be damaged during the crimping procedures.

According to an embodiment, the distance between two adjacent grooves is comprised between, 6 mm and 9 mm, for example of 7.5 mm.

These values assure a proper peeling of the flat magnetic wire, to obtain the electrical connection between the flat magnetic wire and the splice.

According to an embodiment, each serration groove comprises a trapezoidal profile.

In this way, the edges of each serration groove cuts the coating layer of the flat magnetic wire, peeling it and allowing the electrical contact between the flat magnetic wire and the splice.

According to an embodiment, the angle α between the basis and each of the tines is comprised between 92° and 97°, preferably between 93° and 96°, more preferably equal to 94.5°.

Such a configuration of the splice makes the splice particularly suitable to connect a flat magnetic wire.

According to an embodiment, the base has a length along said X direction comprised between 1.5 mm and 5 mm, for example of 3.85 mm.

This makes the splice suitable to connect a flat magnetic wire. A flat magnetic wire, with a with of 3.55 mm, can easily be placed into the splice.

According to an embodiment, the free end of the first tine and/or the free end (4C) of said second tine (4) is tapered.

This facilitates the crimping of the first tine and the second tine around the flat magnetic wire.

The subject matter herein is based on the idea of using a splice to electrically connect a flat magnetic wire, for example of a stator of an electric motor of an electric car.

There are several reasons why it is necessary to find more efficient techniques to connect flat magnetic wires. For example, flat magnetic wires optimize the filling factor in winding process, permit to exchange more electrical power than the standard round wire. Moreover, they permit a better heat dissipation, enable to improve the design of the coil, improve the efficiency of the magnetic field, do to the better frequency characteristics, and enable to improve the design of the coil bringing to a more efficient magnetic field.

For example, a flat magnetic wire can be that of the stator of a high power electric motor, for example of an electric car.

### BRIEF DESCRIPTION OF THE DRAWINGS

The present invention will be described with reference to the attached figures in which the same reference numerals and/or signs indicate the same part and/or similar and/or corresponding parts of the machine.

FIG. 1 shows a 3D view of a splice according to an exemplary embodiment.

FIG. 2 shows the splice shown in FIG. 1, along the XZ plane.

FIG. 3 shows the serration of a splice according to an exemplary embodiment.

FIG. 4 shows the splice shown in FIG. 1, with a flat magnetic wire inserted in it, and overlapped crimped.

FIG. 5 shows a 3D view of a splice according to an exemplary embodiment.

FIG. 6 shows the splice shown in FIG. 4, along the XZ plane.

FIG. 7 shows the splice shown in FIG. 4, in an elongated position.

FIG. 8 shows the splice shown in FIG. 4, with a flat magnetic wire inserted in it, and F crimped.

FIG. 9 shows a crimping machine according to an exemplary embodiment.

### DETAILED DESCRIPTION OF THE INVENTION

In the following, the present invention is described with reference to particular embodiments as shown in the enclosed drawings. Nevertheless, the present invention is not limited to the particular embodiments described in the following detailed description and shown in the figures, but, instead, the embodiments described simply exemplify several aspects of the present invention, the scope of which is defined by the appended claims.

Further modifications and variations of the present invention will be clear for the person skilled in the art. Therefore, the present description has to be considered as including all the modifications and/or variations of the present invention, the scope of which is defined by the appended claims.

For simplicity, identical or corresponding components are indicated in the figures with the same reference numbers.

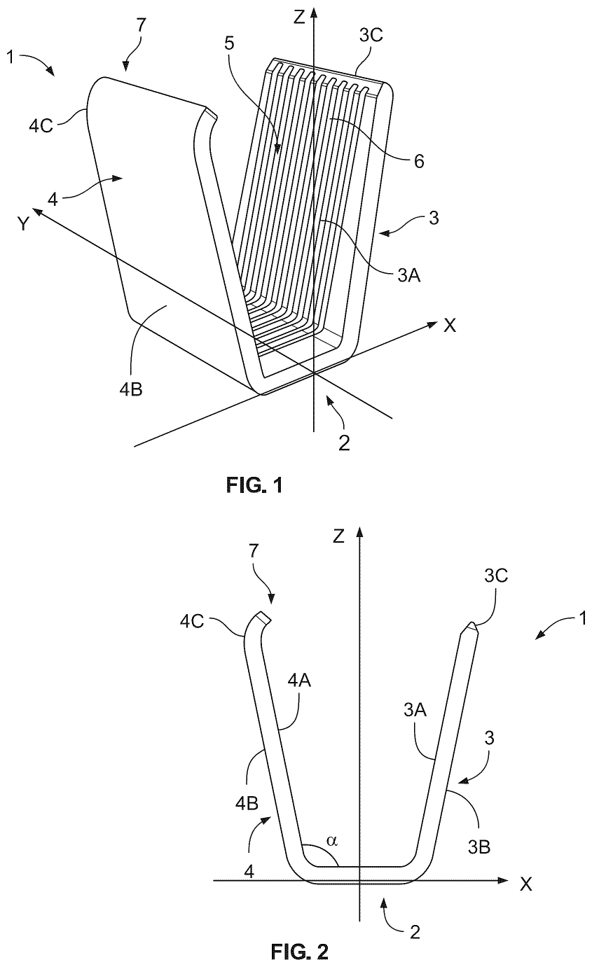

FIG. 1 shows a 3D view of a splice 1 according to an exemplary embodiment.

The splice 1 shown in FIG. 1 includes a base 2, a first tine 3 and a second tine 4.

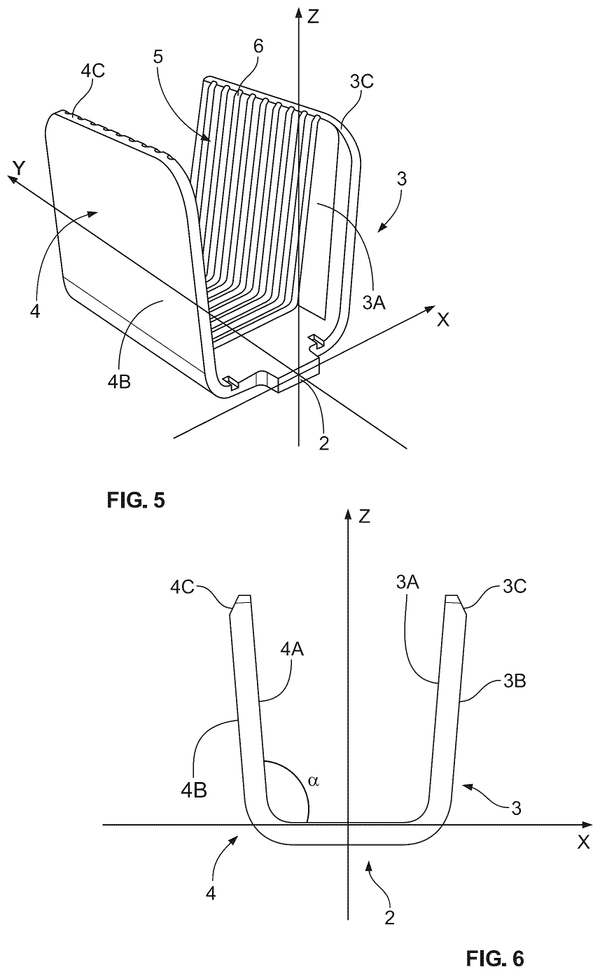

The base 2 is flat and defines a XY plane where the Y direction is parallel to the insertion direction of a flat magnetic wire FMW into the splice 1, as better shown with reference to FIG. 4, and X is the direction perpendicular to the Y direction. More in particular, the Y axis, as shown in FIG. 1, is directed opposite to the insertion direction of the flat magnetic wire FMW inside the splice 1 and divides the base 2 into two equal halves.

A XYZ orthogonal reference system can, therefore, be defined by taking the Z axis so as to be perpendicular to the XY plane.

The first tine 3 and the second tine 4, respectively, protrude from one of the two opposite extremities of the base 2. Since the base 2 is flat, the first tine 3 and the second tine 4 form, with the base 2, a U-shaped structure.

The first tine 3 and the second tine 4 are not symmetric with respect to the ZY plane. The free end 4C of the second tine 4 is, in fact, bent to form a curved structure 7, facing the inner surface 3A of the first tine 3.

The curved structure 7 comprises, in the embodiment shown in FIG. 1, an arc profile with a curvature comprised between 1.6 mm and 2 mm, for example of 1.7 mm. The curved structure can comprise any other suitable profile, for example a linear profile.

Bending the free end 4C of the second tines 4 of the splice 1, toward the inside of the splice 1, i.e. the part of the splice 1 into which the flat magnetic wire FMW is inserted, so as to form a curved structure 7, allow to better close the splice 1 around the flat magnetic wire during the crimping procedure. For the same reason the free end 3C of the first tine 3 comprises a tapered profile.

In fact, when a curved structure 7 is realized on the free end 4C of the second tine 4, and the free end 3C of the first tine 3 has a tapered profile, then an overlapping crimping of the splice 1 around the flat magnetic wire FMW can be realized, as will be described in more detail with reference to FIG. 4.

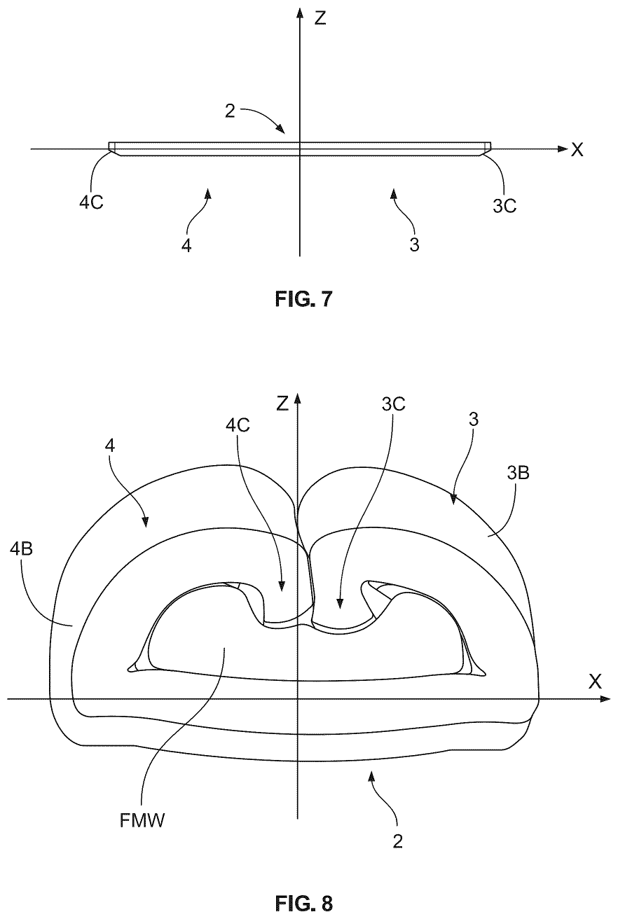

The length of the splice 1 in an elongated state, as shown in FIG. 7, that means with the first tine 3 and the second tine 4 on the XY plane, is greater that 19 mm, for example comprised between 19.1 mm and 30 mm, for example of 28.51 mm.

A standard splice for standard round wires, of the type known from the state of the art, has a length, in an elongated state, comprised between 2.9 mm and 19 mm.

The splice in the illustrated embodiment is, therefore, longer than a standard splice. This feature contributes to adapt the splice so as to terminate a flat magnetic wire, which is larger and thicker that a standard round wire. Moreover, a more stable overlapping crimping can, in this way, be realized.

Splice 1, further, comprises a serration 5 realized on the inner surface 3A of the first tine 3, facing the second tine 4, on the inner surface 2A of the base 2, facing the inner space of the splice 1, and on the inner surface 4A of the second tine 4, facing the first tine 3.

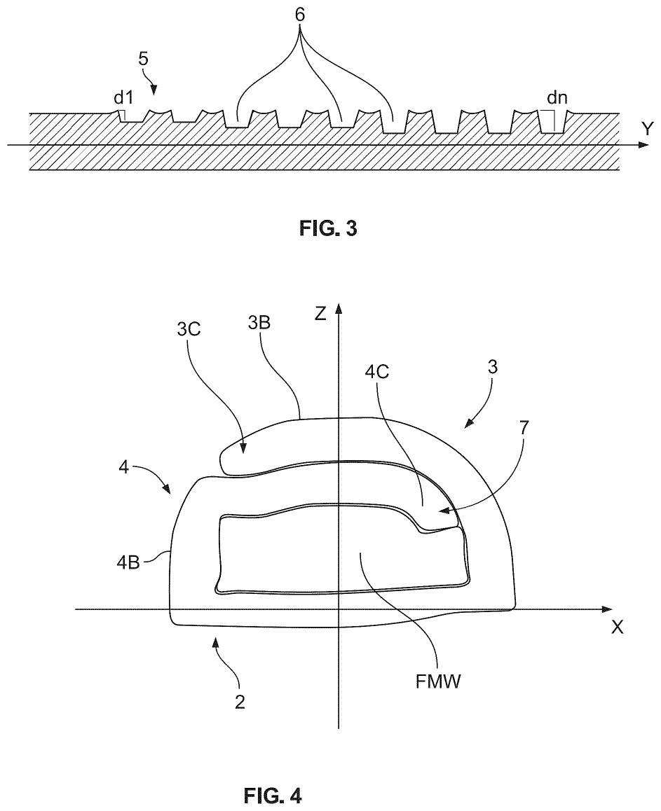

One of the purposes of the serration 5 is to peel the coating layer of the flat magnetic wire FMW when this is crimped inside the splice 1, so as to assure the electrical connection between the flat magnetic wire FMW and the splice 1. Another purpose is to firmly block the flat magnetic wire FMW inside the splice 1, preventing any inappropriate movement of the same, once it has been crimped inside the splice 1. The serration 5 will be described in more detail, with reference to FIG. 3.

The splice according to an exemplary embodiment is made of copper, but any other suitable conductor material can be used.

FIG. 2 shows the splice shown in FIG. 1, along the XZ plane.

FIG. 2 shows a front view of the splice shown in FIG. 1. FIG. 2 clearly shows that the angle α between the basis 2 and each of the tines 3, 4 is comprised between 92° and 97°, preferably between 93° and 96°, more preferably equal to 94.5°.

Such a configuration of the splice makes the splice particularly suitable to connect a flat magnetic wire. Many experiments performed by the inventors of the present invention, confirm such a statement.

FIG. 3 shows the serration of a splice according to an exemplary embodiment.

The serration 5 comprises serration grooves 6, wherein each serration groove 6 extends from the free end 3C of the first tine 3 to the free end 4C of the second tine 4.

The distance, along the Y axis, between two adjacent grooves 6 is comprised between, 6 mm and 9 mm, for example of 7.5 mm.

The serration grooves 6 have a depth dn comprised between 7 mm and 11 mm, for example between 8 mm and 10 mm.

More in particular, the depth dn of the serration grooves 6 increases of a constant value along the Y direction. The flat magnetic wire FMW is inserted inside the splice 1 so that its free end correspond to the serration groove 6 having the shallower depth d1. Such a gradient in the serration grooves depth dn assures the flat magnetic wire FMW not to be damaged during the crimping process.

The number of serration grooves 6 can be, for example comprised between 3 and 9, for example equal to 3, 4, 5, 6, 6, 7, 8 or 9.

Moreover, each serration groove 6 comprises a trapezoidal profile. Such a profile assures a proper peeling of the coating layer of the magnet wire, so that a proper electrical connection between the flat magnetic wire and the splice is realized. Any other suitable profile can be used.

Such a profile also firmly block the flat magnetic wire FMW inside the splice 1. It, in fact, allows the penetration of the serration 5 into the flat magnetic wire FMW, preventing any inappropriate movement of the same, once it has been crimped inside the splice 1.

FIG. 4 shows the splice shown in FIG. 1, with a flat magnetic wire inserted in it, and overlapped crimped.

The figures shows the splice shown in FIG. 1, with a flat magnetic wire FMW inserted in it. The first tine 3 and the second tine 4 of the splice 1 have been bend on the flat magnetic wire FMW during the crimping process. Due to the curved structure 7 on the free end 4C of the second tine 4, and to the tapered free end 3C of the first tine 3, during the crimping process, the second tine 4 slipped under the first tine 3, realizing a so called overlapping crimping. Several experiments, performed by the inventors of the present invention, have shown that such an overlapping can be very convenient, i.e. it produces a very stable connection. A crimping machine to realize a crimping process is shown in FIG. 9 according to an exemplary embodiment.

FIG. 5 shows a 3D view of a splice according to a further embodiment.

The splice 1, according to the embodiment shown in FIG. 5, comprises a base 2, a first tine 3 and a second tine 4.

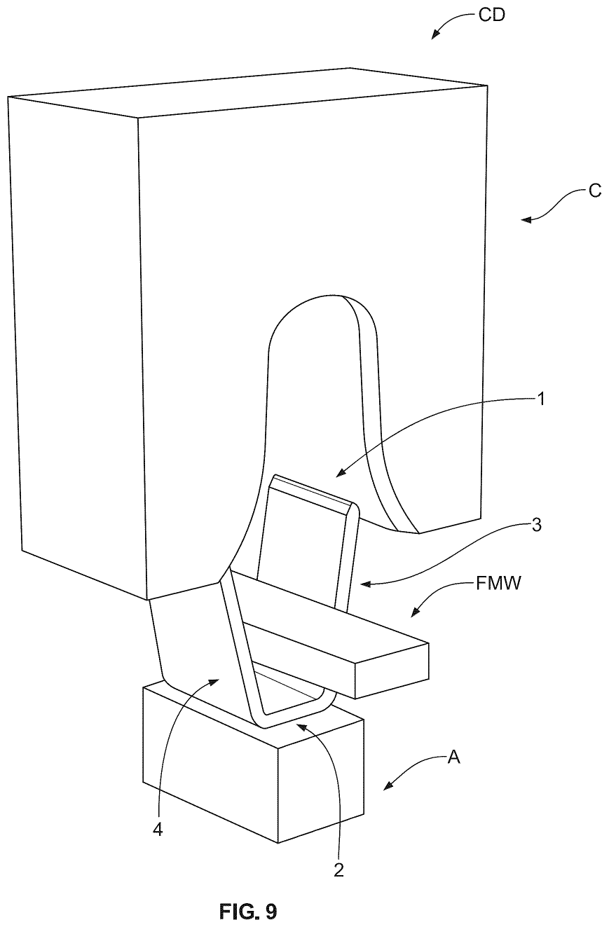

The base 2 is flat and defines a XY plane where the Y direction is parallel to the insertion direction of a flat magnetic wire FMW into the splice 1, as better described with reference to FIG. 8, and X is the direction perpendicular to the Y direction. More in particular, the Y axis is directed opposite to the insertion direction of the flat magnetic wire FMW inside the splice 1 and divides the base 2 into two equal halves.

A XYZ orthogonal reference system can, therefore, be defined by taking the Z axis so as to be perpendicular to the XY plane.

The first tine 3 and the second tine 4, respectively, protrude from one of the two opposite extremities of the base 2. Since the base 2 is flat, the first tine 3 and the second tine 4 form, with the base 2, a U-shaped structure.

The first tine 3 and the second tine 4 are symmetric with respect to the ZY plane. The free end 3C of the first tine 3 and the free end 4C of the second tine 4 are tapered. In this way, the free end 3C of the first tine 3 and the free end 4C of the second tine 4 interact, during the crimping process, so to realize an F crimping, as better shown in FIG. 8.

The length of the splice 1 in an elongated state, as shown in FIG. 7, that means with the first tine 3 and the second tine 4 on the XY plane, is greater than 19 mm, for example comprised between 19.1 mm and 30 mm, for example of 20.95 mm.

A standard splice for standard round wires, of the type known from the state of the art, has a length, in an elongated state, comprised between 2.9 mm and 19 mm.

The splice according to the illustrated embodiment is, therefore, longer than a standard splice. This feature is essential to adapt the splice so as to terminate a flat magnetic wire, which is larger and thicker that a standard round wire. In this way, a stable F crimping can be realized.

Splice 1, further, comprises a serration 5 realized on the inner surface 3A of the first tine 3, facing the second tine 4, on the inner surface 2A of the base 2, facing the inner space of the splice 1, and on the inner surface 4A of the second tine 4, facing the first tine 3.

One of the purposes of the serration 5 is to peel the coating layer of the flat magnetic wire FMW when this is crimped inside the splice 1, so as to assure the electrical connection between the flat magnetic wire FMW and the splice 1. Another purpose is to firmly block the flat magnetic wire FMW inside the splice 1, preventing any inappropriate movement of the same, once it has been crimped inside the splice 1. The serration 5 has already been described in more detail, with reference to FIG. 3.

The splice according to an exemplary embodiment is made of copper, but any other suitable conductor material can be used.

FIG. 6 shows the splice shown in FIG. 5, along the XZ plane.

FIG. 6 shows a front view of the splice shown in FIG. 5. In FIG. 6 is clearly shown that the angle α between the basis 2 and each of the tines 3, 4 is comprised between 92° and 97°, preferably between 93° and 96°, more preferably equal to 94.5°.

Such a configuration of the splice, makes the splice suitable to connect a flat magnetic wire. Many experiments performed by the inventors of the present invention, confirm such a statement.

FIG. 7 shows the splice shown in FIG. 5, in an elongated state.

In the ambit of the present disclosure, “elongated state” refers to a state in which the first tine 3 and the second tine 4 of the splice 1 lay on the same XY plane of the base of the splice, instead of protruding from the base so as to form a U-shaped structure.

The length of the splice 1, from the free end 3C of the first tine 3 to the free end 4C of the second tine 4 is greater that 19 mm, for example comprised between 19.1 mm and 30 mm, for example of 20.95 mm.

FIG. 8 shows the splice shown in FIG. 5, with a flat magnetic wire inserted in it, and F crimped.

The figures shows the splice shown in FIG. 5, with a flat magnetic wire FMW inserted in it. The first tine 3 and the second tine 4 of the splice 1 have been bend on the flat magnetic wire FMW during the crimping process. Due to the tapered profile of the free end 4C of the second tine 4, and the tapered profile of the free end 3C of the first tine 3, during the crimping process, the second tine 4 and the first tine 3, realize a so called F crimping. Several experiments, performed by the inventors of the present invention, have shown that such an F crimping can be very convenient, i.e. it produces a very stable connection. A crimping machine to realize a crimping process is shown in FIG. 9.

FIG. 9 shows a crimping machine according to an exemplary embodiment.

A crimper device CD, as used according to an exemplary embodiment, comprises an anvil A on which the splice 1 is placed and a crimper C to crimp the splice 1. The flat magnetic wire FWM to be connected is put into the splice, then the crimper C crimps the splice 1 on top of the wire FMW.

The crimper C comprises an opening O which can comprise a bell profile or an F profile. The opening O leads the movement of the first tine 3 and of the second tine 4 during the crimping process.

A crimper C comprising an opening O with a bell profile can be used to crimp a splice according to an exemplary embodiment, as shown in FIG. 1, having asymmetric tines. A bell profile, in fact, is more suitable to obtain an overlapping crimping.

A crimper C comprising an opening O with an F profile can be used to crimp a splice according to an exemplary embodiment, as shown in FIG. 5, having symmetric tines. An F profile, in fact, is more suitable to obtain an F crimping.

Even though the present invention has been described with reference to the embodiments described above, it is clear to those skilled in the art that it is possible to make different modifications of the present invention in light of the teaching described above and in the appended claims, without departing from the scope of protection of the invention.

For example, the number of serration grooves shown in the figures is 9, but it can vary according to the needs.

Moreover, according to the embodiments shown, the splice is made of copper, but any other suitable conductor material can be used.

Finally, those aspects that are considered known by those skilled in the art have not been described in order to avoid needlessly excessively obscuring the description of the invention.

Consequently, the invention is not limited to the embodiments described above, but is only limited by the scope of protection of the appended claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. Splice for the electrical connection of a flat magnetic wire, said splice comprising:
a base, a first tine and a second tine, wherein the first time and the second tine each protrude from one of two opposite extremities of said base so as to form a U-shaped structure;
wherein said base is flat so as to define an XY plane, wherein the Y direction is parallel to the insertion direction of said flat magnetic wire into said splice; and
wherein said first tine and said second tine are asymmetric, so as to allow an overlapping crimping of said first tine and said second tine around said flat magnetic wire.

2. Splice according to claim 1, wherein a free end of said second tine is bent to form a curved structure, facing an inner surface of said first tine.

3. Splice according to claim 1, wherein said splice, in an elongated state, has a length greater than 19 mm.

4. Splice according to claim 1, wherein said splice, in an elongated state, has a length of between 19 mm and 30 mm.

5. Splice according to claim 1, further comprising a serration to peel a coating layer of said flat magnetic wire and to secure said flat magnetic wire inside said splice when the splice is crimped around said flat magnetic wire, said serration comprising a plurality of serration grooves, wherein each serration groove extends from a free end of said first tine to a free end of said second tine.

6. Splice according to claim 5, wherein each serration groove has a different depth.

7. Splice according to claim 5, wherein the depth of each said serration groves decreases along the Y direction.

8. Splice according to claim 5, wherein said serration grooves have depths comprised between 7 mm and 11 mm.

9. Splice according to claim 5, wherein depths of said serration grooves decrease of a constant value so that the flat magnetic wire is inserted into the splice parallel to the Y direction and so that a free end of the flat magnetic wire corresponds to the shallower groove.

10. Splice according to claim 5, wherein distances between adjacent grooves is between 6 mm and 9 mm.

11. Splice according to claim 5, wherein each of said serration grooves comprises a trapezoidal profile.

12. Splice according to claim 1, wherein an angle (a) between said base and each of said first and second tines is comprised between 92° and 97°.

13. Splice according to claim 1, wherein said base has a length along the X direction comprised between 1.5 mm and 5 mm.

14. Splice according to claim 1, wherein a free end of said first tine and/or a free end of said second tine is tapered.

15. Splice for the electrical connection of a flat magnetic wire, said splice comprising:
a base, a first tine and a second tine, wherein the first tine and the second tine each protrude from one of two opposite extremities of said base so as to form a U-shaped structure;
wherein said base is flat so as to define an XY plane, wherein the Y direction is parallel to the insertion direction of the flat magnetic wire into the splice, and
wherein said splice, in an elongated state, has a length between 19 mm and 30 mm.

16. Splice according to claim 15, wherein an inner surface of said first tine faces said second tine, an inner surface of said the base faces an inner space of the splice, and an inner surface of said second tine faces said first tine.

17. Splice according to claim 15, further comprising a serration to peel a coating layer of said flat magnetic wire and to secure said flat magnetic wire inside said splice when the splice is crimped around said flat magnetic wire, said serration comprising a plurality of serration grooves, wherein each serration groove extends from a free end of said first tine to a free end of said second tine.

18. Splice according to claim 17, wherein each serration groove has a different depth.

19. Splice according to claim 17, wherein the depth of each said serration groves decreases along the Y direction.

20. Splice according to claim 17, wherein each of said serration grooves comprises a trapezoidal profile.
